(19) United States
(12) Patent Application Publication
(10) Pub. No.: US 2025/0391417 A1
(43) Pub. Date: Dec. 25, 2025

(54) APPARATUS AND METHOD FOR RENDERING MULTI-PATH SOUND DIFFRACTION WITH MULTI-LAYER RASTER MAPS

(71) Applicant: FRAUNHOFER-GESELLSCHAFT ZUR FÖRDERUNG DER ANGEWANDTEN FORSCHUNG E.V., München (DE)

(72) Inventor: Christian BORSS, Erlangen (DE)

(21) Appl. No.: 19/311,935

(22) Filed: Aug. 27, 2025

Related U.S. Application Data
(63) Continuation of application No. PCT/EP2024/055083, filed on Feb. 28, 2024.

(30) Foreign Application Priority Data
Feb. 28, 2023 (EP) 23159188.4

(51) Int. Cl. G10L 19/008; H04S 7/00

(52) U.S. Cl. CPC G10L 19/008; H04S 7/303; H04S 2400/11

(57) ABSTRACT

An apparatus for decoding according to an embodiment is provided. The apparatus comprises an audio signal decoder for decoding an encoding of an audio object signal of an audio object. Moreover, the apparatus comprises a metadata decoder for decoding an encoding of metadata, wherein, for each of a plurality of listener positions, the metadata comprises information on two or more different sound wave propagation paths from a sound source position of the audio object to the listener position. Furthermore, the apparatus comprises a signal generator for generating one or more audio output signals depending on the audio object signal and depending on the information on the two or more different sound wave propagation paths from the sound source position to a current listener position of the plurality of listener positions.

### CROSS-REFERENCE TO RELATED APPLICATIONS

This application is a continuation of copending International Application No. PCT/EP2024/055083, filed Feb. 28, 2024, which is incorporated herein by reference in its entirety, and additionally claims priority from European Application No. 23159188.4, filed Feb. 28, 2023, which is also incorporated herein by reference in its entirety.

The present invention relates to encoding, decoding and rendering of multi-path sound diffraction and, in particular, to encoding, decoding and rendering of multi-path sound diffraction with multi-layer raster maps.

### BACKGROUND OF THE INVENTION

AR/VR systems generate a visual and auditory virtual environment by visualizing and auralizing a virtual scene. Real-time and offline audio rendering auditory scenes and environments is, e.g., described in [1] (see also [1a]).

The auralization process simulates the sound propagation in the virtual environment by taking into account acoustic effects like occlusion, reflection, and diffraction of sound waves. These wave phenomena can be reproduced with great accuracy by solving an acoustical wave equation, but doing so for the whole audible spectrum, is not feasible in real time.

AR/VR systems need low latency audio rendering methods using simplified models like geometric acoustic approaches. For example the image model (IM) can be used to model sound reflections and the uniform theory of diffraction (UTD) can be used to model sound diffraction on the edges of a polygon mesh [2], [3].

Another approach for simplifying the geometry of the acoustic environment is to use voxels (volumetric pixels) where the environment is discretized by a uniform grid of three-dimensional blocks. Shortest path search algorithms like Dijkstra's algorithm, A*, or jump point search can be used to determine the direction from which the first wave front is reaching the listener at a discretized position [4], [5], [6].

By limiting the voxel grid to a certain size or by only considering a two-dimensional cross-section of the geometry, shortest path search algorithms can be used to simulate diffraction effects in real-time. However, only considering the shortest propagation path of the diffracted sound is a strong limitation that can result in clearly audible artefacts. For example when the user of the AR/VR system moves around an occluding and diffracting object, at a certain point the shortest propagation path of the diffracted sound will jump from one side to the other.

### SUMMARY

According to an embodiment, an apparatus for decoding may have: an audio signal decoder for decoding an encoding of an audio object signal of an audio object, a metadata decoder for decoding an encoding of metadata, wherein, for each of a plurality of listener positions, the metadata comprises information on two or more different sound wave propagation paths from a sound source position of the audio object to the listener position; and a signal generator for generating one or more audio output signals depending on the audio object signal and depending on the information on the two or more different sound wave propagation paths from the sound source position to a current listener position of the plurality of listener positions.

According to another embodiment, an apparatus for encoding may have: an audio signal encoder for encoding an audio object signal of an audio object to obtain an encoding of the audio object signal, and a metadata encoder for encoding metadata, wherein, for each of a plurality of listener positions, the metadata comprises information on two or more different sound wave propagation paths from a sound source position of the audio object to the listener position.

According to another embodiment, a system may have: an inventive apparatus for encoding, an inventive apparatus for decoding, wherein the audio signal encoder of the apparatus for encoding is configured to encode an audio object signal of the audio object to obtain the encoding of the audio object signal, wherein the metadata encoder of the apparatus for encoding is configured to encode the metadata, wherein, for each of the plurality of listener positions, the metadata comprises information on two or more different sound wave propagation paths from a sound source position of the audio object to the listener position, wherein the audio signal decoder of the apparatus for decoding is configured to decode the encoding of the audio object signal, wherein the metadata decoder of the apparatus for decoding is configured to decode the encoding of the metadata, and wherein the signal generator of the apparatus for decoding is configured to generate the one or more audio output signals depending on the audio object signal and depending on the information on the two or more different sound wave propagation paths from the sound source position to the current listener position of the plurality of listener positions.

According to another embodiment, a method for decoding may have the steps of: decoding an encoding of an audio object signal of an audio object, decoding an encoding of metadata, wherein, for each of a plurality of listener positions, the metadata comprises information on two or more different sound wave propagation paths from a sound source position of the audio object to the listener position; and generating one or more audio output signals depending on the audio object signal and depending on the information on the two or more different sound wave propagation paths for a current listener position of the plurality of listener positions.

According to another embodiment, a method for encoding may have the steps of: encoding an audio object signal of an audio object to obtain an encoding of the audio object signal, and encoding metadata, wherein, for each of a plurality of listener positions, the metadata comprises information on two or more different sound wave propagation paths from a sound source position of the audio object to the listener position.

Another embodiment may have a non-transitory digital storage medium having a computer program stored thereon to perform any of the inventive methods when said computer program is run by a computer.

An apparatus for decoding according to an embodiment is provided. The apparatus comprises an audio signal decoder for decoding an encoding of an audio object signal of an audio object. Moreover, the apparatus comprises a metadata decoder for decoding an encoding of metadata, wherein, for each of a plurality of listener positions, the metadata comprises information on two or more different sound wave propagation paths from a sound source position of the audio object to the listener position. Furthermore, the apparatus comprises a signal generator for generating one or more audio output signals depending on the audio object signal and depending on the information on the two or more different sound wave propagation paths from the sound source position to a current listener position of the plurality of listener positions.

Moreover, an apparatus for encoding according to an embodiment is provided. The apparatus comprises an audio signal encoder for encoding an audio object signal of an audio object to obtain an encoding of the audio object signal. Moreover, the apparatus comprises a metadata encoder for encoding metadata, wherein, for each of a plurality of listener positions, the metadata comprises information on two or more different sound wave propagation paths from a sound source position of the audio object to the listener position.

Furthermore, a method for decoding according to an embodiment is provided. The method comprises:
Decoding an encoding of an audio object signal of an audio object.
Decoding an encoding of metadata, wherein, for each of a plurality of listener positions, the metadata comprises information on two or more different sound wave propagation paths from a sound source position of the audio object to the listener position. And:
Generating one or more audio output signals depending on the audio object signal and depending on the information on the two or more different sound wave propagation paths for a current listener position of the plurality of listener positions.

Furthermore, a method for encoding according to an embodiment is provided. The method comprises:
Encoding an audio object signal of an audio object to obtain an encoding of the audio object signal. And:
Encoding metadata, wherein, for each of a plurality of listener positions, the metadata comprises information on two or more different sound wave propagation paths from a sound source position of the audio object to the listener position.

Furthermore, a computer program for implementing one of the above-described methods when being executed on a computer or signal processor is provided.

When in the following, reference is made to a coordinate position, this is to be understood as a position that is defined with respect to a coordinate system, e.g., with respect to a two-dimensional coordinate system, or with respect to a three-dimensional coordinate system. E.g., for a two-dimensional coordinate system, a coordinate position is defined by two coordinates of a coordinate system. E.g., for a three-dimensional coordinate system, a coordinate position is defined by three coordinates of a coordinate system. For example, (2;4) is a coordinate position of a two-dimensional coordinate system.

E.g., a coordinate position is a position that is defined by, e.g., two or more coordinates of a coordinate system.

Embodiments provide a computation of multi-layer maps/graphs and its efficient encoding.

### BRIEF DESCRIPTION OF THE DRAWINGS

Embodiments of the present invention will be detailed subsequently referring to the appended drawings, in which:

FIG. 1 illustrates an apparatus for decoding according to an embodiment.

FIG. 2 illustrates an apparatus for encoding according to another embodiment.

FIG. 3 illustrates a system according to an embodiment.

FIG. 4 illustrates an example for a multi-layer raster map where two diffraction paths around a rectangular diffracting object are determined for a source using two raster map layers.

FIG. 5 illustrates a propagation of the sound waves, depicted in the lower layer raster map and in the upper layer raster map of FIG. 4.

FIG. 6 illustrates the raster data of the lower layer raster map and of the upper layer raster map for the example depicted by FIG. 4 and FIG. 5.

### DETAILED DESCRIPTION OF THE INVENTION

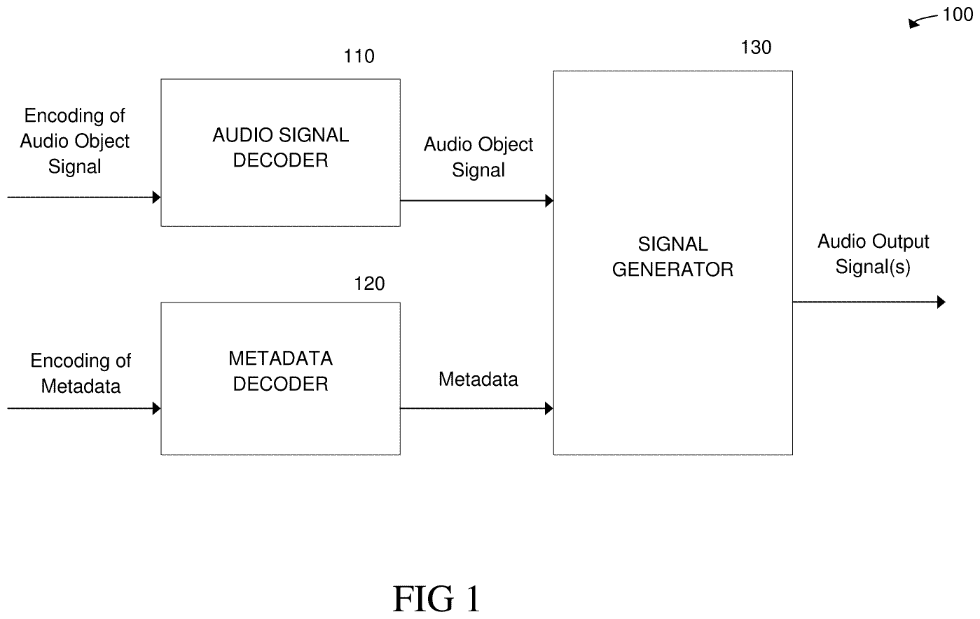

FIG. 1 illustrates an apparatus 100 for decoding according to an embodiment.

The apparatus 100 comprises an audio signal decoder 110 for decoding an encoding of an audio object signal of an audio object.

Moreover, the apparatus 100 comprises a metadata decoder 120 for decoding an encoding of metadata, wherein, for each of a plurality of listener positions, the metadata comprises information on two or more different sound wave propagation paths from a sound source position of the audio object to the listener position.

Furthermore, the apparatus 100 comprises a signal generator 130 for generating one or more audio output signals depending on the audio object signal and depending on the information on the two or more different sound wave propagation paths from the sound source position to a current listener position of the plurality of listener positions.

For example, the metadata comprises for a possible listener position information at least two sound wave propagation paths from a sound source position to the listener position. Moreover, the metadata does not only comprise such information for only one possible listener position, but for two or more possible listener positions (“a plurality of listener positions”).

The embodiment of FIG. 1 realizes that the information on the two or more sound wave propagation paths for an actual/current listener positions out of the information for the plurality of possible listener positions is taken into account, when generating the audio output signal(s).

According to an embodiment, at least one of the two or more different sound wave propagation paths from the sound source position to one of the plurality of listener positions depends on a diffraction of a sound wave, originating from the sound source position, at an object.

E.g., at least one sound wave may, e.g., be diffracted.

In an embodiment, a first one of the two or more different sound wave propagation paths from the sound source position to one of the plurality of listener positions represents a shortest path for a sound wave to propagate from the sound source position to said one of the plurality of listener positions, and wherein one or more other sound wave propagation paths of the two or more different sound wave propagation paths are different from said shortest path.

The propagation paths for which information may, e.g., be provided in the metadata comprise the shortest sound wave propagation path and one or more other propagation paths.

According to an embodiment, information on a second sound wave propagation path of the two or more different sound wave propagation paths from the sound source position to one of the plurality of listener positions reuses information on a first sound wave propagation path of the two or more different sound wave parts.

The information on a second propagation path reuses information on the first propagation path

In an embodiment, the first sound wave propagation path of the two or more different sound wave propagation paths may, e.g., be said shortest path for a sound wave to propagate from the sound source position to said one of the plurality of listener positions.

In particular, the information on the shortest propagation path may, e.g., be reused for providing information on the other propagation paths; e.g., higher-layer raster maps reuse the lowest layer raster map

According to an embodiment, the metadata may, e.g., comprise information on a first sound wave propagation path of the two or more different sound wave propagation paths, wherein said information may, e.g., comprise first raster data of a first raster map of one or more raster maps, wherein the first raster data depends on the first sound wave propagation path. The signal generator 130 may, e.g., be configured to process the first raster data to generate the one or more audio output signals.

The first propagation path may, e.g., be represented by information that relates to a first raster map.

In an embodiment, the first raster map may, e.g., be a two-dimensional raster map or may, e.g., be a three-dimensional raster map.

According to an embodiment, for each coordinate position of at least some of a plurality of coordinate positions of the first raster map, the raster data indicates a subsequent coordinate position of the first raster map, such that a line from said coordinate position to said subsequent coordinate position indicates a portion of the first sound wave propagation path in reverse direction for a listener position that may, e.g., be located at said coordinate position, when the subsequent coordinate position may, e.g., be different from the sound source position, and indicates a complete first sound wave propagation path in reverse direction for a listener position that may, e.g., be located at said coordinate position, when the subsequent coordinate position may, e.g., be equal to the sound source position.

E.g., a coordinate position is a position that is defined by, e.g., two or more coordinates of a coordinate system.

A coordinate position references another coordinate position, a line (not necessarily, but advantageously a straight line) represents a portion of the propagation path.

Here, in reverse direction means that while a sound wave propagates from the sound source position to the listener position, in contrast, an arrow from the coordinate position to its subsequent coordinate position points in a reverse/opposite direction of the propagation of the sound wave.

In an embodiment, the metadata may, e.g., comprise information on a second sound wave propagation path of the two or more different sound wave propagation paths, wherein said information may, e.g., comprise second raster data of a second raster map of the one or more raster maps, wherein the second raster data depends on the second sound wave propagation path. The information on the second sound wave propagation path further may, e.g., comprise information on the first raster map to indicate the second sound wave propagation path. The signal generator 130 may, e.g., be configured to process the second raster data to generate the one or more audio output signals.

The second raster map may, e.g., be linked with the first raster map, reuses the information in the first raster map, and coordinate positions in the second raster map point on positions in the first raster map.

According to an embodiment, the first raster map and the second raster map are two-dimensional raster maps. Or, the first raster map and the second raster map are three-dimensional raster maps.

In an embodiment, for each coordinate position of at least some of a plurality of coordinate positions of the second raster map, the raster data indicates a subsequent coordinate position of the second raster map, such that a line from said coordinate position to said subsequent coordinate position indicates a portion of the second sound wave propagation path in reverse direction for a listener position that may, e.g., be located at said coordinate position.

In the second raster map, coordinate positions reference other coordinate positions in the second raster map (as in the first raster map)

According to an embodiment, for each of one or more further coordinate positions of the plurality of coordinate positions of the second raster map, the raster data indicates a subsequent coordinate position of the first raster map, such that a line from said coordinate position to said subsequent coordinate position indicates a portion of the second sound wave propagation path in reverse direction for a listener position that may, e.g., be located at said coordinate position, and such that the first raster map indicates one or more further portions of the second sound wave propagation path between said subsequent coordinate position and the sound source position.

Coordinate position(s) in the second raster map reference coordinate positions in the first raster map (and thus reuse the first raster map.

For example, the second raster map may, for example, be a two-dimensional raster map. For a coordinate position of the second raster may, the subsequent coordinate position may, e.g., be specified by its x-coordinate value, by its y-coordinate value and by a map index, which indicates whether the next coordinate belongs to the second raster map or to the first raster map.

For example, (x; y; mapChange) may indicate the subsequent coordinate position, wherein x indicates the x-coordinate value, wherein y indicates the y-coordinate value and wherein mapChange indicates whether the next coordinate position may, e.g., be a coordinate position of the second raster map (0) or of the first raster map (1).

For example, mapChange may, e.g., be a binary value.

E.g., regarding the first raster map, in an embodiment, a coordinate position may, e.g., be only specified by (x; y), as a map change does not occur regarding the first raster map.

With respect to a third raster map, a binary value mapChange may, e.g., indicate whether the subsequent coordinate position relates to the third raster map (mapChange=0) or to the second raster map (mapChange=1).

These principles equally apply for three dimensional raster maps, which, in addition, also comprise a z-coordinate. For example, in (x; y; z; mapChange), x indicates the x-coordinate value, y indicates the y-coordinate value, z indicates the z-coordinate value and mapChange indicates whether the subsequent coordinate position may, e.g., be located in the current raster map (e.g., the second raster map) or in the preceding raster map (e.g., the first raster map).

In an embodiment, the signal generator 130 may, e.g., be configured to generate the one or more audio output signals by fading out an influence of the second sound wave propagation path on a generation of the one or more audio output signals compared to an influence of the first sound wave propagation path on the generation of the one or more audio output signals depending on a distance of the current listener position to a collision area of a first sound wave propagating along the first sound wave propagation path with a second sound wave propagating along the second sound wave propagation path.

A fade out at the collision area of sound waves propagating along the different propagation paths may, e.g., be conducted.

According to an embodiment, the signal generator 130 may, e.g., be configured to generate the one or more audio output signals by fading out the influence of the second sound wave propagation path on the generation of the one or more audio output signals the closer the current listener position may, e.g., be located to the collision area.

E.g., more fading of the non-dominant sound wave may, e.g., be conducted close to the collision area.

In an embodiment, the metadata may, e.g., comprise information on a third sound wave propagation path of the two or more different sound wave propagation paths, wherein said information may, e.g., comprise raster data of a third raster map of the one or more raster maps, wherein the third raster data depends on the third sound wave propagation path. For each coordinate position of at least some of a plurality of coordinate positions of the third raster map, the raster data indicates a subsequent coordinate position of the third raster map, such that a line from said coordinate position to said subsequent coordinate position indicates a portion of the third sound wave propagation path in reverse direction for a listener position that may, e.g., be located at said coordinate position. For each of one or more further coordinate positions of the plurality of coordinate positions of the third raster map, the raster data indicates a subsequent coordinate position of the second raster map, such that a line from said coordinate position to said subsequent coordinate position indicates a portion of the third sound wave propagation path in reverse direction for a listener position that may, e.g., be located at said coordinate position, and such that the second raster map indicates one or more further portions of the third sound wave propagation path. The signal generator 130 may, e.g., be configured to process the third raster data to generate the one or more audio output signals.

Such an embodiment describes providing and using information on a third sound wave propagation path (this case may, e.g., be similar as for the second sound wave propagation path), but references a coordinate in the second raster map.

According to an embodiment, the metadata decoder 120 may, e.g., be configured to decode an encoding of raster data of the one or more raster maps, wherein the encoding of the raster data encodes the raster data in a compressed way.

Compression of the raster data may, e.g., be employed. This may, e.g., be important, because a lot coordinate positions will point to the same subsequent coordinate position (e.g., at corners of an object, as indicated by the figure provided in the invention report)

In an embodiment, the raster data may, e.g., be entropy-encoded within the encoding of the raster data.

According to an embodiment, the signal generator 130 may, e.g., be configured to generate the one or more audio output signals by attenuating the audio object signal depending on one or more diffraction angles along at least one of the two or more different sound wave propagation paths.

In an embodiment, the signal generator 130 may, e.g., be configured to generate the one or more audio output signals by attenuating the audio object signal differently for different frequency components of the audio object signal, depending on the one or more diffraction angles along at least one of the two or more different sound wave propagation paths and depending a frequency.

Such an embodiment covers a frequency-dependent and diffraction-dependent attenuation.

According to an embodiment, the signal generator 130 may, e.g., be configured to generate the one or more audio output signals depending on the one or more diffraction angles such that higher frequency components of the audio object signal are attenuated more than lower frequency components.

In other words, higher frequency components may, e.g., be attenuated more than lower frequency components

In an embodiment, the metadata decoder 120 may, e.g., be configured to determine a sum of all diffraction angles for said at least one of the two or more different sound wave propagation paths. The signal generator 130 may, e.g., be configured to generate the one or more audio output signals by attenuating the audio object signal depending on said sum of all diffraction angles.

According to an embodiment, at least one of the two or more different sound wave propagation paths from the sound source position to one of the plurality of listener positions depends on a reflection of a sound wave, originating from the sound source position, at an object.

In an embodiment, the sound source position may, e.g., be one of two or more sound source positions, wherein the audio object signal may, e.g., be one of two or more audio object signals, wherein the audio object may, e.g., be one of two or more audio objects. The audio signal decoder 110 may, e.g., be configured to decode an encoding of the two or more audio object signals of the two or more audio objects. The metadata decoder 120 may, e.g., be configured to decode the metadata comprising information, for each sound source position of the two or more sound source positions, on two or more different sound wave propagation paths from said sound source position of one of the two or more audio objects to a listener position for each of a plurality of listener positions. The signal generator 130 may, e.g., be configured to generate the one or more audio output signals depending on the two or more audio object signals and depending on the information on the two or more different sound wave propagation paths from a sound source position to the current listener position for each of the two or more sound source positions.

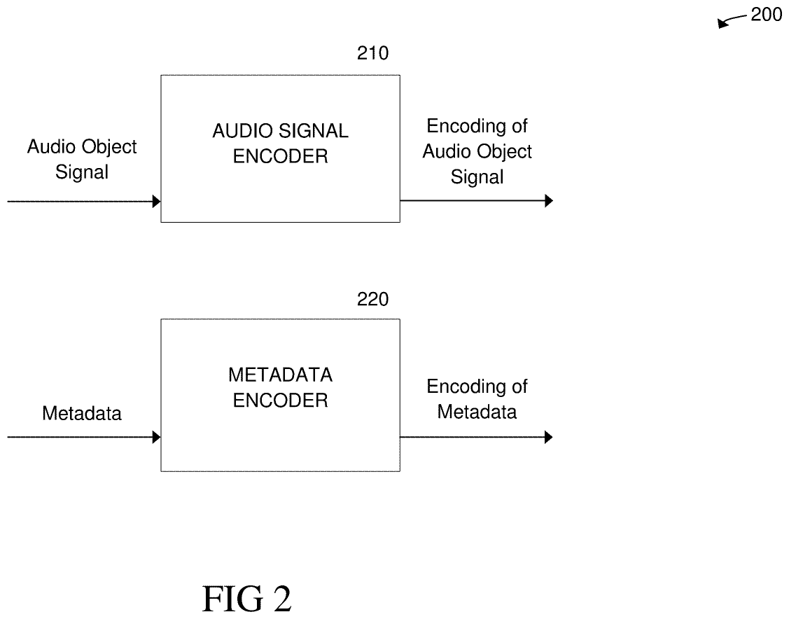

FIG. 2 illustrates an apparatus 200 for encoding according to an embodiment.

The apparatus 200 comprises an audio signal encoder 210 for encoding an audio object signal of an audio object to obtain an encoding of the audio object signal.

Moreover, the apparatus 200 comprises a metadata encoder 220 for encoding metadata, wherein, for each of a plurality of listener positions, the metadata comprises information on two or more different sound wave propagation paths from a sound source position of the audio object to the listener position.

According to an embodiment, at least one of the two or more different sound wave propagation paths from the sound source position to one of the plurality of listener positions depends on a diffraction of a sound wave, originating from the sound source position, at an object.

In an embodiment, a first one of the two or more different sound wave propagation paths from the sound source position to one of the plurality of listener positions represents a shortest path for a sound wave to propagate from the sound source position to said one of the plurality of listener positions, and wherein one or more other sound wave propagation paths of the two or more different sound wave propagation paths are different from said shortest path.

According to an embodiment, information on a second sound wave propagation path of the two or more different sound wave propagation paths from the sound source position to one of the plurality of listener positions reuses information on a first sound wave propagation path of the two or more different sound wave parts.

In an embodiment, the first sound wave propagation path of the two or more different sound wave propagation paths may, e.g., be said shortest path for a sound wave to propagate from the sound source position to said one of the plurality of listener positions.

According to an embodiment, the metadata may, e.g., comprise information on a first sound wave propagation path of the two or more different sound wave propagation paths, wherein said information may, e.g., comprise first raster data of a first raster map of one or more raster maps, wherein the first raster data depends on the first sound wave propagation path.

In an embodiment, the first raster map may, e.g., be a two-dimensional raster map or may, e.g., be a three-dimensional raster map.

According to an embodiment, for each coordinate position of at least some of a plurality of coordinate positions of the first raster map, the raster data indicates a subsequent coordinate position of the first raster map, such that a line from said coordinate position to said subsequent coordinate position indicates a portion of the first sound wave propagation path in reverse direction for a listener position that may, e.g., be located at said coordinate position, when the subsequent coordinate position may, e.g., be different from the sound source position, and indicates a complete first sound wave propagation path in reverse direction for a listener position that may, e.g., be located at said coordinate position, when the subsequent coordinate position may, e.g., be equal to the sound source position.

In an embodiment, the metadata may, e.g., comprise information on a second sound wave propagation path of the two or more different sound wave propagation paths, wherein said information may, e.g., comprise second raster data of a second raster map of the one or more raster maps, wherein the second raster data depends on the second sound wave propagation path. The information on the second sound wave propagation path further may, e.g., comprise information on the first raster map to indicate the second sound wave propagation path.

According to an embodiment, the first raster map and the second raster map are two-dimensional raster maps. Or, the first raster map and the second raster map are three-dimensional raster maps.

In an embodiment, for each coordinate position of at least some of a plurality of coordinate positions of the second raster map, the raster data indicates a subsequent coordinate position of the second raster map, such that a line from said coordinate position to said subsequent coordinate position indicates a portion of the second sound wave propagation path in reverse direction for a listener position that may, e.g., be located at said coordinate position.

According to an embodiment, for each of one or more further coordinate positions of the plurality of coordinate positions of the second raster map, the raster data indicates a subsequent coordinate position of the first raster map, such that a line from said coordinate position to said subsequent coordinate position indicates a portion of the second sound wave propagation path in reverse direction for a listener position that may, e.g., be located at said coordinate position, and such that the first raster map indicates one or more further portions of the second sound wave propagation path between said subsequent coordinate position and the sound source position.

In an embodiment, the metadata encoder 220 may, e.g., be configured to generate first raster data of the first raster map and the second raster data of the second raster map by employing a flood-filling algorithm starting with generating the first raster data of the first raster map before generating the second raster data of the second raster map.

According to an embodiment, the metadata encodes information on a collision area of a first sound wave propagating along the first sound wave propagation path with a second sound wave propagating along the second sound wave propagation path.

In an embodiment, the metadata may, e.g., comprise information on a third sound wave propagation path of the two or more different sound wave propagation paths, wherein said information may, e.g., comprise raster data of a third raster map of the one or more raster maps, wherein the third raster data depends on the third sound wave propagation path. For each coordinate position of at least some of a plurality of coordinate positions of the third raster map, the raster data indicates a subsequent coordinate position of the third raster map, such that a line from said coordinate position to said subsequent coordinate position indicates a portion of the third sound wave propagation path in reverse direction for a listener position that may, e.g., be located at said coordinate position. For each of one or more further coordinate positions of the plurality of coordinate positions of the third raster map, the raster data indicates a subsequent coordinate position of the second raster map, such that a line from said coordinate position to said subsequent coordinate position indicates a portion of the third sound wave propagation path in reverse direction for a listener position that may, e.g., be located at said coordinate position, and such that the second raster map indicates one or more further portions of the third sound wave propagation path.

According to an embodiment, the metadata encoder 220 may, e.g., be configured to generate the encoding of the metadata such that an encoding of raster data of the one or more raster maps may, e.g., be encoded in a compressed way.

In an embodiment, the metadata encoder 220 may, e.g., be configured to generate the encoding of the metadata such that the raster data may, e.g., be entropy-encoded within the encoding of the raster data.

According to an embodiment, the metadata encodes information on one or more diffraction angles along at least one of the two or more different sound wave propagation paths.

In an embodiment, at least one of the two or more different sound wave propagation paths from the sound source position to one of the plurality of listener positions depends on a reflection of a sound wave, originating from the sound source position, at an object.

According to an embodiment, the sound source position may, e.g., be one of two or more sound source positions, wherein the audio object signal may, e.g., be one of two or more audio object signals, wherein the audio object may, e.g., be one of two or more audio objects. The audio signal encoder 210 may, e.g., be configured to encode the two or more audio object signals of the two or more audio objects. The metadata encoder 220 may, e.g., be configured to encode the metadata comprising information, for each sound source position of the two or more sound source positions, on two or more different sound wave propagation paths from said sound source position of one of the two or more audio objects to a listener position for each of a plurality of listener positions.

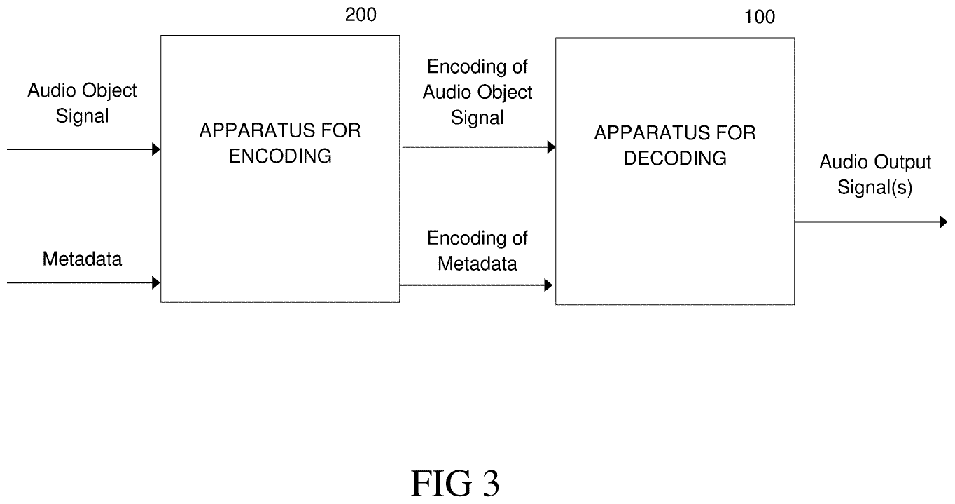

FIG. 3 illustrates a system according to an embodiment.

The system comprises the apparatus 200 for encoding of FIG. 2.

Moreover, the system comprises the apparatus 100 for decoding of FIG. 1.

The audio signal encoder 210 of the apparatus 200 for encoding is configured to encode an audio object signal of the audio object to obtain the encoding of the audio object signal.

The metadata encoder 220 of the apparatus 200 for encoding is configured to encode the metadata, wherein, for each of the plurality of listener positions, the metadata comprises information on two or more different sound wave propagation paths from a sound source position of the audio object to the listener position.

The audio signal decoder 110 of the apparatus 100 for decoding is configured to decode the encoding of the audio object signal.

The metadata decoder 120 of the apparatus 100 for decoding is configured to decode the encoding of the metadata.

The signal generator 130 of the apparatus 100 for decoding is configured to generate the one or more audio output signals depending on the audio object signal and depending on the information on the two or more different sound wave propagation paths from the sound source position to the current listener position of the plurality of listener positions.

In the following, particular embodiments are described. When reference is made to a voxel or voxels, such example embodiments equally apply to a position or positions of a two-dimensional raster map.

According to embodiments, a method for computing multiple diffraction paths for voxel-based geometries is provided. The audio renderer uses multi-layer raster maps which store for each voxel the next waypoint of the shortest propagation path. Each layer of the multi-layer raster map gives an additional propagation path from a discretized sound source position to a discretized listener position.

A multi-layer raster map yields a directed graph with voxel coordinates being the nodes of this graph. Propagation paths can then be determined by tracing the graph from a listener voxel to the origin, which is the voxel where the sound source is located. Each layer of the multi-layer raster map comprises either waypoints belonging to the same layer or waypoints belonging to the next lower layer. For example, if 2 diffraction paths shall be rendered for a given listener voxel, 2 raster map layers are used. The shortest propagation path is determined via back-tracing using the lower raster map layer, starting at the listener voxel. The second propagation path is determined via back-tracing using the upper raster map layer. The number of supported propagation paths can be increased by adding additional raster map layers and hence increasing the number of entry nodes of the back-tracing graph.

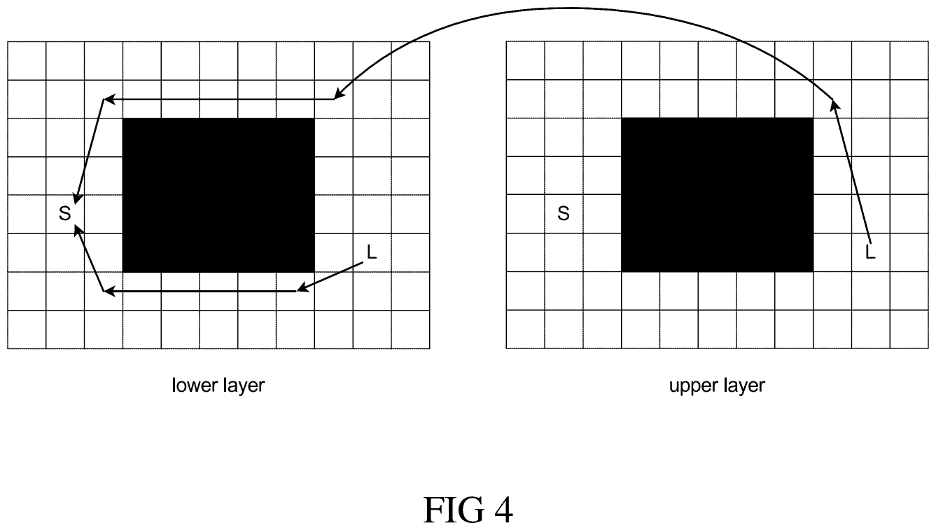

FIG. 4 illustrates an example for a multi-layer raster map where two diffraction paths around a rectangular diffracting object are determined for a source using two raster map layers. It should be noted that only the relevant map entries are illustrated for better readability. S indicates a source position and L indicates a listener position.

The raster map layers can be generated by a modified flood-filling algorithm that is executed for each layer, starting at the lowest layer. The iterative algorithm uses a list of voxels which were updated during the previous iteration. For the lowest layer, this list comprises initially only the source voxel. In each iteration, the neighbors of the updated voxels are checked. If the line-of-sight between the waypoint of the updated voxel and the neighbor is not blocked and the resulting back-tracing path is shorter than before or does not yet exist, then the waypoint of the updated voxel is stored as waypoint for the neighbor and the neighbor is added to the list of updated voxels for the next iteration. The algorithm terminates, when the updated voxel list remains empty.

For the next layer, voxels are identified where “waves” from 2 different directions are colliding. This is the case, when there is at least one neighbor whose back-tracing path differs (is neither the beginning of the other back-tracing path nor is the other back-tracing path the beginning of the current back-tracing path). These colliding voxels are used as initial list of updated voxels for the algorithm, which is executed to yield the next map layer.

The knowledge about the positions of those wave collision voxels can also be used to fade-out higher-order diffraction paths. Such artefacts may occur, when the listener moves to another voxel and the back-tracing path changes. By fading-out a diffraction path beyond a certain distance from the wave collision voxel, a smooth transition can be achieved.

Alternatively, a diffraction path can be faded out, if the difference of the back-tracing path length between 2 map layers exceed a certain threshold.

The simulation of diffraction effects usually involves a distance-dependent attenuation (the sound pressure is reciprocal to the distance of a point source) and an additional frequency-dependent attenuation that depends on the diffraction angle. When using multi-layer raster maps, the total length r of the back-tracing path can be used for simulating the 1/r distance attenuation. Furthermore, the bending angles of the back-tracing path can be used for taking into account the frequency-dependent attenuation. This can either be done by calculating a frequency-dependent attenuation for each waypoint of the back-tracing path using UTD [3] or by a simplification, for example by scaling a prototype filter A_{ref}(ƒ) in dB, which was determined for a reference angle α_{ref}, by the accumulated bending angle α:

$${A}_{α} ( f ) = \frac{α}{{α}_{ref}} {A}_{ref} ( f )$$

Another aspect according to an embodiment is the efficient transmission of the pre-computed multi-layer raster map: The data that needs to be transmitted are the voxel coordinates (incl. the map layer) and the corresponding voxel data, e.g., the waypoints of the map.

According to an embodiment, since many voxels have neighbors with identical waypoints, the voxel data comprises a lot of redundancy which can be reduced by inter-voxel redundancy reduction and generic codebooks, see [7], [8].

Furthermore, according to an embodiment, if the data is transmitted sequentially, also the voxel coordinates comprises a lot of redundancy which can be reduced by voxel coordinate prediction, see [9].

Embodiments offer multi-path diffraction for voxel scenes, e.g., for scenes where geometry is represented by voxels instead of meshes. For voxel-based AR/VR scenes, this greatly reduces the artefacts of single-path diffraction rendering.

Embodiments find application in auralization, e.g., real-time and offline audio rendering auditory scenes and environments, see [1], (see also [1a]). This includes Virtual Reality (VR) and Augmented Reality (AR) systems like the MPEG-I 6-DoF Immersive Audio renderer.

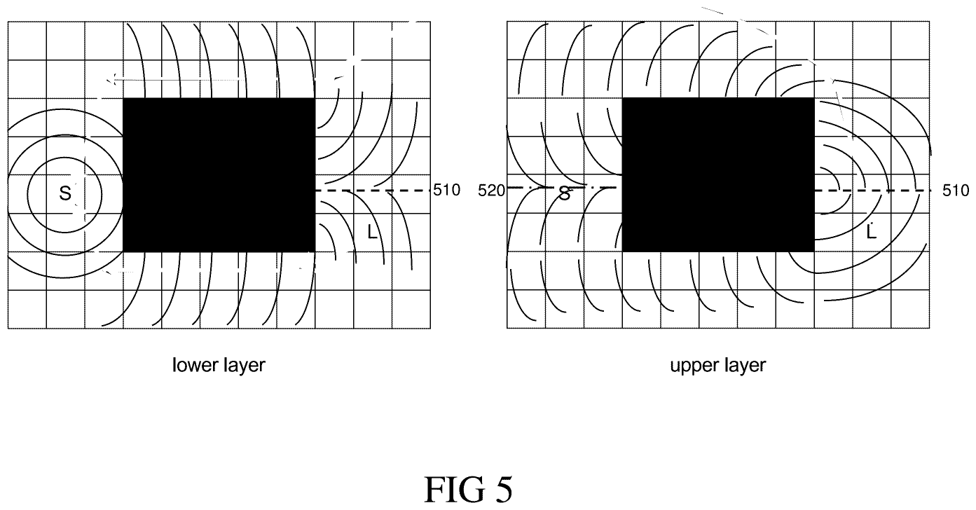

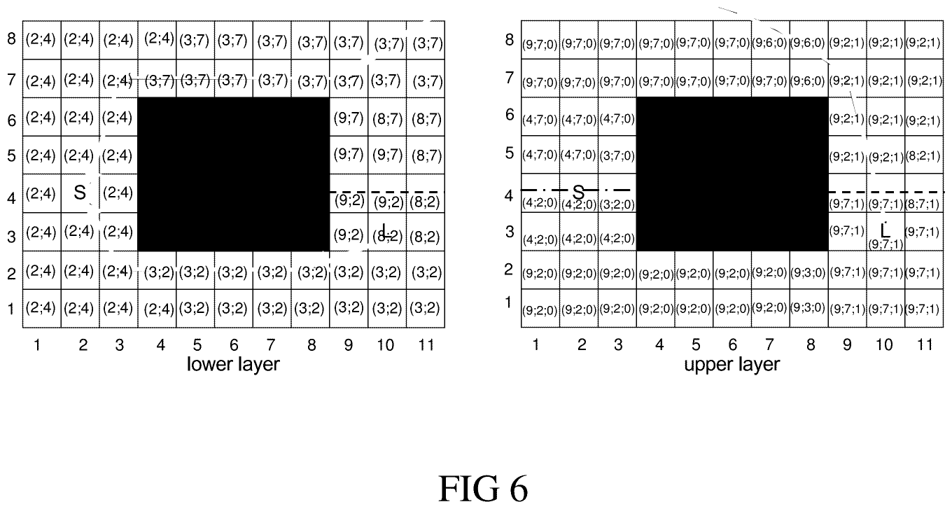

In the following, further particular embodiments are described referring to FIG. 5 and FIG. 6 with define particular embodiments of the embodiment of FIG. 4.

FIG. 5 illustrates a propagation of the sound waves, depicted in the lower layer raster map and in the upper layer raster map of FIG. 4.

In particular, FIG. 5 depicts the sound waves that originate from the sound source position/the audio object position.

In FIG. 5, left, it can be seen that the sound waves originate from the sound source position, that the sound waves are then diffracted at an object and propagate further around the object, in FIG. 5, left, either on the left side of the object (in FIG. 5, left, illustrated in the top area of said figure) or on the right side of the object (in FIG. 5, left, illustrated in the bottom area of said figure). After the sound waves have passed the object, the sound waves that have passed the object on the left side (top area of FIG. 5, left) and the sound waves that have passed the object on the right side (bottom area of FIG. 5, left) “collide” with each other at a collision area; in FIG. 5, depicted by a collision line 510. (In fact, physically, what happens is that the sound waves overlap.) The sound waves then propagate further into the areas where the respective other sound waves originate from, but this is not illustrated in FIG. 5 left, and the first raster map/the lower layer shall not represent that further propagation of the sound waves.

However, when referring to FIG. 5, right, what is shown there is indeed the further propagation of the sound waves into the respective other area beyond the collision line 510.

Thus, the bottom area of FIG. 5, right, shows an example of how the sound waves which have passed the object on its left side (in the top area of FIG. 5, left) further propagate into the other area (into the bottom area of FIG. 5, right) beyond the collision line 510. Likewise, the top area of FIG. 5, right, shows how the sound waves which have passed the object on its right side (in the bottom area of FIG. 5, left) further propagate into the other area (into the top area of FIG. 5, right) beyond the collision line 510. Again, the sound waves collide at another collision area; in FIG. 5, right, depicted by collision line 520. All this is represented by the second raster map/the upper layer.

It would be similarly possible to continue the description of the propagation of the sound waves with a third raster map/a second upper layer which describes the propagation of the sound waves beyond the second collision line 520. Likewise, it would be possible to continue the description of the sound waves for even further layers, e.g., with a fourth raster map (a third upper layer), a fifth raster map (a fourth upper layer), a sixth raster map (a fifth upper layer), etc.

FIG. 6 illustrates the raster data of the first raster map (the lower layer raster map) and of the second raster map (the upper layer raster map) for the example depicted by FIG. 4 and FIG. 5.

In particular, FIG. 6, left, illustrates how to completely represent the sound wave propagation for the lower layer/the first raster map, e.g., the propagation of the sound waves before the sound waves collide at the first collision line (510 in FIG. 5). Although FIG. 6 illustrates raster data for two-dimensional positions, in other embodiments, the approach is extended for three-dimensional positions, e.g., by adding a z-coordinate value.

The raster data realizes a back-tracing approach. That means that for each (useful, e.g., a position where a sound wave could propagate) considered coordinate position in the raster map of FIG. 6, left, a subsequent coordinate position is indicated, such that at least a portion of a propagation path of a sound wave from the sound source position to the considered position is described by a line between the considered coordinate position and the subsequent coordinate position, and such that an arrow from the considered coordinate position to the subsequent coordinate position points in reverse/opposite direction of the propagation direction of the sound waves.

As can be seen in FIG. 6, left, for each (useful) coordinate position, a subsequent coordinate position is indicated to describe a propagation path in reverse/opposite direction, so that at the end, when following the indicated subsequent coordinate positions, one arrives at the sound source position.

For example, in FIG. 6, left, all coordinate positions in the first to third column (with an x-coordinate value between 1 and 3) directly indicate coordinate position (2;4), i.e., the coordinate position of the sound source/of the audio object, as the subsequent coordinate position.

Other coordinate positions in FIG. 6, left, from which the sound source position is shadowed by the object, reference another coordinate position to describe only a portion of the propagation path. For example, coordinate positions (6;2), (6;1) and other coordinate positions indicate coordinate position (3;2) as a subsequent coordinate position to describe a portion of the propagation path from the sound source to the respective position. Then in coordinate position (3;2), however, coordinate position (3;2) again references the sound source position (2;4) as subsequent coordinate position.

As an example, consider coordinate position (11;3). The referenced subsequent coordinate position is (8;2). Coordinate position (8;2) indicates coordinate position (3;2) as subsequent coordinate position. Coordinate position (3;2) then indicates coordinate position (2;4), i.e., the sound source position as subsequent coordinate position. Therefore, in this example, the propagation path of the sound wave starting from (2;4) towards (11;3) thus starts from (2;4) and then extends along (3;2), (8;2) to finally reach coordinate position (11;3).

For example, to indicate that a coordinate position, here (2;4), is indeed the sound source position, the coordinate position may, e.g., reference itself as subsequent coordinate position, which may cause a detection algorithm to determine that said position is indeed the sound source position. (E.g., coordinate position (2;4) may, e,g., indicate (2;4) as subsequent coordinate position to indicate that itself is the sound source position). In other embodiments, other concepts may, e.g., be employed to identify that a subsequent position is a sound source position, e.g., specifying for a coordinate position after how many steps the sound source position is reached, or, e.g., by using a bit to indicate for a coordinate position whether or not said coordinate position is the sound source position, etc.

The propagation of the sound waves beyond the (first) collision area, here, collision line 510 of FIG. 5, is illustrated by FIG. 6, right. This second raster map comprises, for its coordinate positions a third value to indicate the subsequent coordinate position. As in FIG. 6, left, the first and second coordinate values describe the subsequent coordinate position by its x-coordinate value and its y-coordinate value.

To identify the subsequent coordinate position in the second raster map (the upper layer), a third value is indicated. Said third value indicates whether the subsequent coordinate position is located in the second raster map/the upper layer raster map (in FIG. 6, right, this is indicated by a third value being 0), or whether the subsequent coordinate position is located in the first raster map/the lower layer raster map (in FIG. 6, right, this is indicated by a third value being 1). Thus, such a third value may, e.g., be realized by a binary value that can be interpreted as “change to previous raster map”; see “mapChange” described above. Other concepts for realizing said third value are likewise possible, such as indicating an identifier that identifies the raster map in which the subsequent coordinate position is located.

For example, in the upper layer raster map, FIG. 6, right, one may consider coordinate position (3;8):

As subsequent coordinate position, coordinate position (3;8) of FIG. 6, right, indicates (9;7;0). I.e., the subsequent coordinate position is coordinate position (9;7) in the same (upper layer/second) raster map in FIG. 6, right, because the third value is zero.

As subsequent coordinate position, coordinate position (9;7) of FIG. 6, right, indicates (9;2;1). I.e., the subsequent coordinate position is coordinate position (9;2) in the previous (lower layer/first) raster map, FIG. 6, left, because the third value is 1.

As subsequent coordinate position, coordinate position (9;2) of the lower layer/the first raster map, FIG. 6, left, indicates (3;2). I.e., the subsequent coordinate position is coordinate position (3;2) in the lower layer/first raster map, FIG. 6, left.

As subsequent coordinate position, coordinate position (3;2) of FIG. 6, left, indicates (2;4), i.e., the sound source position.

The found reverse/inverse propagation path is therefore defined by the coordinate positions: (3;8), (9;7), (9;2), (3;2), (2;4).

In correct order, starting from the sound source position and defined towards the considered position, this second propagation path from the sound source position towards coordinate position (3;8) is defined as: (2;4), (3;2), (9;2), (9;7), (3;8).

Thus, for two raster maps, two sound wave propagation paths from the sound source position into a particular coordinate position are defined. The first propagation path is defined only by the first raster map; the second one is defined by the second raster map together with the first raster map.

For example, for coordinate position (3;8), the first propagation path is defined as a direct propagation path from (2;4) to (3;8), as the first raster map indicates for (3;8) the coordinate position (2;8) as subsequent coordinate position.

The concept is equally applicable for further upper layers/for further raster maps, e.g., a third raster map, a fourth raster map, a fifth raster map, etc.

Each further layer/further raster map defines another propagation path for each coordinate position for which a subsequent coordinate position is defined.

For example, for a third raster map, the third propagation path may, e.g., be defined by the third raster map together with the second raster map, together with the first raster map. In such an example, some of the coordinate positions of the third raster map indicate coordinate positions of the second raster map, and some of the coordinate positions of the second raster map indicate coordinate positions of the first raster map.

As can be seen in the example of FIG. 6, a lot of coordinate positions comprise a same subsequent coordinate position. This allows efficient encoding of the subsequent coordinate positions. For example, entropy encoding may, e.g., be employed.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] ISO/IEC JTC1/SC29/WG6 N0211, “WD5 of ISO_IEC 23090-4, MPEG-I Immersive Audio”, October 2023, Hannover, DE.
[1a] ISO/IEC JTC1/SC29/WG6 M61258 “Third version of Text of Working Draft of RM0”, 8th WG 6 meeting, October 2022.
[2] Allen, J. B., & Berkley, D. A. (1979). Image method for efficiently simulating small-room acoustics. The Journal of the Acoustical Society of America, 65 (4), 943-950.
[3] R. G. Kouyoumjian and P. H. Pathak, “A uniform geometrical theory of diffraction for an edge in a perfectly conducting surface,” in Proceedings of the IEEE, vol. 62, no. 11, pp. 1448-1461 November 1974, doi: 10.1109/PROC.1974.9651.
[4] Dijksta, E. W. (1959). A note on two problems in connexion with graphs. Numerische Mathematik, 1 (1), 269-271.
[5] P. E. Hart, N. J. Nilsson and B. Raphael, “A Formal Basis for the Heuristic Determination of Minimum Cost Paths,” in IEEE Transactions on Systems Science and Cybernetics, vol. 4, no. 2, pp. 100-107, July 1968, doi: 10.1109/TSSC.1968.300136.
[6] Harabor, D., & Grastien, A. (2011 August). Online graph pruning for pathfinding on grid maps. In Proceedings of the AAAI Conference on Artificial Intelligence (Vol. 25, No. 1, pp. 1114-1119).
[7] International Patent Application PCT/EP2022/069522, “Encoding of pre-computed data for rendering early reflections in AR/VR systems”.
[8] International Patent Application PCT/EP2022/069523, “Encoding of AR/VR metadata with generic codebooks”.
[9] European Patent Application, Application Number EP 22216666.2, “Apparatus and Method for Predicting Voxel Coordinates for AR/VR Systems”.

1. An apparatus for decoding, wherein the apparatus comprises:
an audio signal decoder for decoding an encoding of an audio object signal of an audio object,
a metadata decoder for decoding an encoding of metadata, wherein, for each of a plurality of listener positions, the metadata comprises information on two or more different sound wave propagation paths from a sound source position of the audio object to the listener position; and
a signal generator for generating one or more audio output signals depending on the audio object signal and depending on the information on the two or more different sound wave propagation paths from the sound source position to a current listener position of the plurality of listener positions.

2. An apparatus according to claim 1,
wherein at least one of the two or more different sound wave propagation paths from the sound source position to one of the plurality of listener positions depends on a diffraction of a sound wave, originating from the sound source position, at an object.

3. An apparatus according to claim 1,
wherein a first one of the two or more different sound wave propagation paths from the sound source position to one of the plurality of listener positions represents a shortest path for a sound wave to propagate from the sound source position to said one of the plurality of listener positions, and wherein one or more other sound wave propagation paths of the two or more different sound wave propagation paths are different from said shortest path.

4. An apparatus according to claim 1,
wherein information on a second sound wave propagation path of the two or more different sound wave propagation paths from the sound source position to one of the plurality of listener positions reuses information on a first sound wave propagation path of the two or more different sound wave parts.

5. An apparatus according to claim 3,
wherein information on a second sound wave propagation path of the two or more different sound wave propagation paths from the sound source position to one of the plurality of listener positions reuses information on a first sound wave propagation path of the two or more different sound wave parts; and
wherein the first sound wave propagation path of the two or more different sound wave propagation paths is said shortest path for a sound wave to propagate from the sound source position to said one of the plurality of listener positions.

6. An apparatus according to claim 1,
wherein the metadata comprises information on a first sound wave propagation path of the two or more different sound wave propagation paths, wherein said information comprises first raster data of a first raster map of one or more raster maps, wherein the first raster data depends on the first sound wave propagation path,
wherein the signal generator is configured to process the first raster data to generate the one or more audio output signals.

7. An apparatus according to claim 6,
wherein the first raster map is a two-dimensional raster map or is a three-dimensional raster map.

8. An apparatus according to claim 6,
wherein for each coordinate position of at least some of a plurality of coordinate positions of the first raster map, the raster data indicates a subsequent coordinate position of the first raster map, such that a line from said coordinate position to said subsequent coordinate position
indicates a portion of the first sound wave propagation path in reverse direction for a listener position that is located at said coordinate position, when the subsequent coordinate position is different from the sound source position,
indicates a complete first sound wave propagation path in reverse direction for a listener position that is located at said coordinate position, when the subsequent coordinate position is equal to the sound source position.

9. An apparatus according to claim 6,
wherein the metadata comprises information on a second sound wave propagation path of the two or more different sound wave propagation paths, wherein said information comprises second raster data of a second raster map of the one or more raster maps, wherein the second raster data depends on the second sound wave propagation path,
wherein the information on the second sound wave propagation path further comprises information on the first raster map to indicate the second sound wave propagation path,
wherein the signal generator is configured to process the second raster data to generate the one or more audio output signals.

10. An apparatus according to claim 9,
wherein the first raster map and the second raster map are two-dimensional raster maps; or
wherein the first raster map and the second raster map are three-dimensional raster maps.

11. An apparatus according to claim 9,
wherein for each coordinate position of at least some of a plurality of coordinate positions of the second raster map, the raster data indicates a subsequent coordinate position of the second raster map, such that a line from said coordinate position to said subsequent coordinate position indicates a portion of the second sound wave propagation path in reverse direction for a listener position that is located at said coordinate position.

12. An apparatus according to claim 9,
wherein for each of one or more further coordinate positions of the plurality of coordinate positions of the second raster map, the raster data indicates a subsequent coordinate position of the first raster map, such that a line from said coordinate position to said subsequent coordinate position indicates a portion of the second sound wave propagation path in reverse direction for a listener position that is located at said coordinate position, and such that the first raster map indicates one or more further portions of the second sound wave propagation path between said subsequent coordinate position and the sound source position.

13. An apparatus according to claim 9,
wherein the signal generator is configured to generate the one or more audio output signals by fading out an influence of the second sound wave propagation path on a generation of the one or more audio output signals compared to an influence of the first sound wave propagation path on the generation of the one or more audio output signals depending on a distance of the current listener position to a collision area of a first sound wave propagating along the first sound wave propagation path with a second sound wave propagating along the second sound wave propagation path.

14. An apparatus according to claim 13,
wherein the signal generator is configured to generate the one or more audio output signals by fading out the influence of the second sound wave propagation path on the generation of the one or more audio output signals the closer the current listener position is located to the collision area.

15. An apparatus according to claim 6,
wherein the metadata comprises information on a third sound wave propagation path of the two or more different sound wave propagation paths, wherein said information comprises raster data of a third raster map of the one or more raster maps, wherein the third raster data depends on the third sound wave propagation path,
wherein for each coordinate position of at least some of a plurality of coordinate positions of the third raster map, the raster data indicates a subsequent coordinate position of the third raster map, such that a line from said coordinate position to said subsequent coordinate position indicates a portion of the third sound wave propagation path in reverse direction for a listener position that is located at said coordinate position,
wherein for each of one or more further coordinate positions of the plurality of coordinate positions of the third raster map, the raster data indicates a subsequent coordinate position of the second raster map, such that a line from said coordinate position to said subsequent coordinate position indicates a portion of the third sound wave propagation path in reverse direction for a listener position that is located at said coordinate position, and such that the second raster map indicates one or more further portions of the third sound wave propagation path,
wherein the signal generator is configured to process the third raster data to generate the one or more audio output signals.

16. An apparatus according to claim 6,
wherein the metadata decoder is configured to decode an encoding of raster data of the one or more raster maps, wherein the encoding of the raster data encodes the raster data in a compressed way.

17. An apparatus according to claim 16,
wherein the raster data is entropy-encoded within the encoding of the raster data.

18. An apparatus according to claim 1,
wherein the signal generator is configured to generate the one or more audio output signals by attenuating the audio object signal depending on one or more diffraction angles along at least one of the two or more different sound wave propagation paths.

19. An apparatus according to claim 18,
wherein the signal generator is configured to generate the one or more audio output signals by attenuating the audio object signal differently for different frequency components of the audio object signal, depending on the one or more diffraction angles along at least one of the two or more different sound wave propagation paths and depending a frequency.

20. An apparatus according to claim 19,
wherein the signal generator is configured to generate the one or more audio output signals depending on the one or more diffraction angles such that higher frequency components of the audio object signal are attenuated more than lower frequency components.

21. An apparatus according to claim 18,
wherein the metadata decoder is configured to determine a sum of all diffraction angles for said at least one of the two or more different sound wave propagation paths, and
wherein the signal generator is configured to generate the one or more audio output signals by attenuating the audio object signal depending on said sum of all diffraction angles.

22. An apparatus according to claim 1,
wherein at least one of the two or more different sound wave propagation paths from the sound source position to one of the plurality of listener positions depends on a reflection of a sound wave, originating from the sound source position, at an object.

23. An apparatus according to claim 1,
wherein the sound source position is one of two or more sound source positions, wherein the audio object signal is one of two or more audio object signals, wherein the audio object is one of two or more audio objects,
wherein the audio signal decoder is configured to decode an encoding of the two or more audio object signals of the two or more audio objects,
wherein the metadata decoder is configured to decode the metadata comprising information, for each sound source position of the two or more sound source positions, on two or more different sound wave propagation paths from said sound source position of one of the two or more audio objects to a listener position for each of a plurality of listener positions;
wherein the signal generator is configured to generate the one or more audio output signals depending on the two or more audio object signals and depending on the information on the two or more different sound wave propagation paths from a sound source position to the current listener position for each of the two or more sound source positions.

24. An apparatus for encoding, wherein the apparatus comprises:
an audio signal encoder for encoding an audio object signal of an audio object to obtain an encoding of the audio object signal, and
a metadata encoder for encoding metadata, wherein, for each of a plurality of listener positions, the metadata comprises information on two or more different sound wave propagation paths from a sound source position of the audio object to the listener position.

25. An apparatus according to claim 24,
wherein at least one of the two or more different sound wave propagation paths from the sound source position to one of the plurality of listener positions depends on a diffraction of a sound wave, originating from the sound source position, at an object.

26. An apparatus according to claim 24,
wherein a first one of the two or more different sound wave propagation paths from the sound source position to one of the plurality of listener positions represents a shortest path for a sound wave to propagate from the sound source position to said one of the plurality of listener positions, and wherein one or more other sound wave propagation paths of the two or more different sound wave propagation paths are different from said shortest path.

27. An apparatus according to claim 24,
wherein information on a second sound wave propagation path of the two or more different sound wave propagation paths from the sound source position to one of the plurality of listener positions reuses information on a first sound wave propagation path of the two or more different sound wave parts.

28. An apparatus according to claim 26,
wherein information on a second sound wave propagation path of the two or more different sound wave propagation paths from the sound source position to one of the plurality of listener positions reuses information on a first sound wave propagation path of the two or more different sound wave parts; and
wherein the first sound wave propagation path of the two or more different sound wave propagation paths is said shortest path for a sound wave to propagate from the sound source position to said one of the plurality of listener positions.

29. An apparatus according to claim 24,
wherein the metadata comprises information on a first sound wave propagation path of the two or more different sound wave propagation paths, wherein said information comprises first raster data of a first raster map of one or more raster maps, wherein the first raster data depends on the first sound wave propagation path.

30. An apparatus according to claim 29,
wherein the first raster map is a two-dimensional raster map or is a three-dimensional raster map.

31. An apparatus according to claim 29,
wherein for each coordinate position of at least some of a plurality of coordinate positions of the first raster map, the raster data indicates a subsequent coordinate position of the first raster map, such that a line from said coordinate position to said subsequent coordinate position
indicates a portion of the first sound wave propagation path in reverse direction for a listener position that is located at said coordinate position, when the subsequent coordinate position is different from the sound source position, indicates a complete first sound wave propagation path in reverse direction for a listener position that is located at said coordinate position, when the subsequent coordinate position is equal to the sound source position.

32. An apparatus according to claim 29,
wherein the metadata comprises information on a second sound wave propagation path of the two or more different sound wave propagation paths, wherein said information comprises second raster data of a second raster map of the one or more raster maps, wherein the second raster data depends on the second sound wave propagation path,
wherein the information on the second sound wave propagation path further comprises information on the first raster map to indicate the second sound wave propagation path.

33. An apparatus according to claim 32,
wherein the first raster map and the second raster map are two-dimensional raster maps; or
wherein the first raster map and the second raster map are three-dimensional raster maps.

34. An apparatus according to claim 32,
wherein for each coordinate position of at least some of a plurality of coordinate positions of the second raster map, the raster data indicates a subsequent coordinate position of the second raster map, such that a line from said coordinate position to said subsequent coordinate position indicates a portion of the second sound wave propagation path in reverse direction for a listener position that is located at said coordinate position.

35. An apparatus according to claim 32,
wherein for each of one or more further coordinate positions of the plurality of coordinate positions of the second raster map, the raster data indicates a subsequent coordinate position of the first raster map, such that a line from said coordinate position to said subsequent coordinate position indicates a portion of the second sound wave propagation path in reverse direction for a listener position that is located at said coordinate position, and such that the first raster map indicates one or more further portions of the second sound wave propagation path between said subsequent coordinate position and the sound source position.

36. An apparatus according to claim 32,
wherein the metadata encoder is configured to generate first raster data of the first raster map and the second raster data of the second raster map by employing a flood-filling algorithm starting with generating the first raster data of the first raster map before generating the second raster data of the second raster map.

37. An apparatus according to claim 32,
wherein the metadata encodes information on a collision area of a first sound wave propagating along the first sound wave propagation path with a second sound wave propagating along the second sound wave propagation path.

38. An apparatus according to claim 29,
wherein the metadata comprises information on a third sound wave propagation path of the two or more different sound wave propagation paths, wherein said information comprises raster data of a third raster map of the one or more raster maps, wherein the third raster data depends on the third sound wave propagation path,
wherein for each coordinate position of at least some of a plurality of coordinate positions of the third raster map, the raster data indicates a subsequent coordinate position of the third raster map, such that a line from said coordinate position to said subsequent coordinate position indicates a portion of the third sound wave propagation path in reverse direction for a listener position that is located at said coordinate position,
wherein for each of one or more further coordinate positions of the plurality of coordinate positions of the third raster map, the raster data indicates a subsequent coordinate position of the second raster map, such that a line from said coordinate position to said subsequent coordinate position indicates a portion of the third sound wave propagation path in reverse direction for a listener position that is located at said coordinate position, and such that the second raster map indicates one or more further portions of the third sound wave propagation path.

39. An apparatus according to claim 29,
wherein the metadata encoder is configured to generate the encoding of the metadata such that an encoding of raster data of the one or more raster maps is encoded in a compressed way.

40. An apparatus according to claim 39,
wherein the metadata encoder is configured to generate the encoding of the metadata such that the raster data is entropy-encoded within the encoding of the raster data.

41. An apparatus according to claim 24,
wherein the metadata encodes information on one or more diffraction angles along at least one of the two or more different sound wave propagation paths.

42. An apparatus according to claim 24,
wherein at least one of the two or more different sound wave propagation paths from the sound source position to one of the plurality of listener positions depends on a reflection of a sound wave, originating from the sound source position, at an object.

43. An apparatus according to claim 24,
wherein the sound source position is one of two or more sound source positions, wherein the audio object signal is one of two or more audio object signals, wherein the audio object is one of two or more audio objects,
wherein the audio signal encoder is configured to encode the two or more audio object signals of the two or more audio objects,
wherein the metadata encoder is configured to encode the metadata comprising information, for each sound source position of the two or more sound source positions, on two or more different sound wave propagation paths from said sound source position of one of the two or more audio objects to a listener position for each of a plurality of listener positions.

44. A system, comprising:
an apparatus for encoding, wherein the apparatus comprises:
an audio signal encoder for encoding an audio object signal of an audio object to obtain an encoding of the audio object signal, and
a metadata encoder for encoding metadata, wherein, for each of a plurality of listener positions, the metadata comprises information on two or more different sound wave propagation paths from a sound source position of the audio object to the listener position, and
an apparatus for decoding according to claim 1,
wherein the audio signal encoder of the apparatus for encoding is configured to encode an audio object signal of the audio object to obtain the encoding of the audio object signal,
wherein the metadata encoder of the apparatus for encoding is configured to encode the metadata, wherein, for each of the plurality of listener positions, the metadata comprises information on two or more different sound wave propagation paths from a sound source position of the audio object to the listener position,
wherein the audio signal decoder of the apparatus for decoding is configured to decode the encoding of the audio object signal,
wherein the metadata decoder of the apparatus for decoding is configured to decode the encoding of the metadata, and
wherein the signal generator of the apparatus for decoding is configured to generate the one or more audio output signals depending on the audio object signal and depending on the information on the two or more different sound wave propagation paths from the sound source position to the current listener position of the plurality of listener positions.

45. A method for decoding, wherein the method comprises:
decoding an encoding of an audio object signal of an audio object,
decoding an encoding of metadata, wherein, for each of a plurality of listener positions, the metadata comprises information on two or more different sound wave propagation paths from a sound source position of the audio object to the listener position; and
generating one or more audio output signals depending on the audio object signal and depending on the information on the two or more different sound wave propagation paths for a current listener position of the plurality of listener positions.

46. A method for encoding, wherein the method comprises:
encoding an audio object signal of an audio object to obtain an encoding of the audio object signal, and
encoding metadata, wherein, for each of a plurality of listener positions, the metadata comprises information on two or more different sound wave propagation paths from a sound source position of the audio object to the listener position.

47. A non-transitory digital storage medium having a computer program stored thereon to perform the method of claim 45 or 46 when said computer program is run by a computer.
